(19) United States
(12) Patent Application Publication
(10) Pub. No.: US 2026/0217875 A1
(43) Pub. Date: Jul. 30, 2026

(54) PREPARATION OF BRANCHED POLYDIENES AND POLYDIENE COPOLYMERS

(71) Applicant: Bridgestone Corporation, Tokyo (JP)

(72) Inventors: Sem Raj TAMANG, Stow, OH (US); Madoka KIMURA, Kawasaki-shi, Kanagawa (JP); Bret J. CHISHOLM, North Canton, OH (US); Terrence E. HOGAN, Uniontown, OH (US); Laura S. KOCSIS, Akron, OH (US); Rita E. COOK, Akron, OH (US); Vrushali BHAGAT, Cuyahoga Falls, OH (US)

(21) Appl. No.: 19/145,697

(22) PCT Filed: Jan. 3, 2024
(86) PCT No.: PCT/US2024/010177

§ 371 Date: Jul. 3, 2025

Related U.S. Application Data
(60) Provisional application No. 63/478,276, filed on Jan. 3, 2023.

(51) Int. Cl. C08F 8/42; C08K 3/36

(52) U.S. Cl. CPC C08F 8/42; C08K 3/36; C08F 2810/40

(57) ABSTRACT

A method for preparing a branched polymer, the method comprising (i) preparing a multi-site initiator by reacting polyalkenyl compound with an alkyl lithium compound; (ii) introducing the multi-site initiator, monomer, and a potassium alkoxide to form a polymerization mixture, where the polymerization mixture includes a molar ratio of potassium to lithium of greater than 0.150:1; and (iii) allowing the monomer to polymerize and form a branched polymer.

### FIELD OF THE INVENTION

Embodiments of the present invention provide a method for preparing branched polydienes and polydiene copolymers, as well as multi-functional polymers and the use of the branched polymers in the preparation of tire components.

### BACKGROUND OF THE INVENTION

Polydienes, such as poly(butadiene) and diene copolymers, such as poly(styrene-co-butadiene) are often made by employing anionic polymerization techniques whereby diene monomer, optionally together with copolymerizable monomer such as vinyl aromatics, are polymerized using an anionic initiator. The use of anionic polymerization techniques leads to several advantages including the ability to control molecular weight, prepare relatively linear polymer chains, and functionalize the polymer chain through a chain termination reaction. Useful anionic initiators may include, for example, alkyl lithium compounds such as n-butyl lithium. Multi-functional initiators can be formed by reacting, for example, an alkyl lithium compound with a dialkenyl compound such as diisopropenylbenzene. Polymers prepared by using multi-functional initiators have multiple reactive chain ends, which provides the ability to functionalize both ends of a polymer chain to form a telechelic polymer.

### SUMMARY OF THE INVENTION

One or more embodiments of the present invention provide a method for preparing a branched polymer, the method comprising (i) preparing a multi-site initiator by reacting polyalkenyl compound with an alkyl lithium compound; (ii) introducing the multi-site initiator, monomer, and a potassium alkoxide to form a polymerization mixture, where the polymerization mixture includes a molar ratio of potassium to lithium of greater than 0.150:1; and (iii) allowing the monomer to polymerize and form a branched polymer.

Other embodiments of the present invention provide a vulcanizable composition comprising (i) a branched polymer prepared by providing preparing a multi-site initiator by reacting polyalkenyl compound with an alkyl lithium compound; introducing the multi-site initiator, monomer, and a potassium alkoxide to form a polymerization mixture, where the polymerization mixture includes a molar ratio of potassium to lithium of greater than 0.150:1; and allowing the monomer to polymerize and form a branched polymer; (ii) silica; and a curative.

Yet other embodiments of the present invention provide a method for forming a vulcanizable composition, the method comprising (i) providing a branched polymer, where the branched polymer is prepared by providing preparing a multi-site initiator by reacting polyalkenyl compound with an alkyl lithium compound; introducing the multi-site initiator, monomer, and a potassium alkoxide to form a polymerization mixture, where the polymerization mixture includes a molar ratio of potassium to lithium of greater than 0.150:1; and allowing the monomer to polymerize and form a branched polymer; (ii) providing silica; (iii) providing a curative; and (iv) mixing the branched polymer, silica, and curative to form the vulcanizable composition.

### DETAILED DESCRIPTION OF ILLUSTRATIVE EMBODIMENTS

Embodiments of the invention are based, at least in part, on the discovery of a method to prepare branched polydienes and diene copolymers. According to embodiments of the invention, the branched polymers are prepared by anionically polymerizing monomer with a multisite initiator in the presence of a threshold amount of potassium alkoxide. While the prior art contemplates preparing branched polymers by employing multisite initiators, such as those prepared by reacting 1,3-diisopropenylbenzene with an alkyl lithium compound, it has been found that when polymerization takes place in the presence of a threshold amount of the potassium alkoxide, an unexpectedly high degree of branching is achieved as evidenced by viscoelastic properties. Initiator aging in the presence of a Lewis base has also been found to contribute to improved branching. Inasmuch as the polymers are prepared by anionic polymerization techniques, the branching advantageously leads to multiple polymer live ends (i.e. reactive ends), which allows for preparing multifunctional polymers.

### Preparation of Branched Copolymers

In one or more embodiments, the branched polydienes and diene copolymers, which may be referred to as branched polymers, are prepared by polymerizing diene monomer, optionally together with vinyl aromatic monomer, with a multifunctional initiator in the presence of a threshold amount of potassium alkoxide. The multifunctional initiator is prepared by reacting an alkyl lithium with a polyalkenyl compound. In one or more embodiments, the multifunctional initiator is aged in an appropriate solvent in the presence of a Lewis base prior to its use in polymerization.

### Initiator Preparation and Aging

As indicated above, the initiator is prepared by combining a polyalkenyl compound with an alkyl lithium compound within a solvent that forms a reaction mixture in which the reactants and product are at least partially soluble. The initiator is then aged in an appropriate solvent in the presence of a Lewis base.

In one or more embodiments, the polyalkenyl compound is a 1,3-dialkenylbenzene compound such as 1,3-diisopropenylbenzene. In one or more embodiments, the alkyl lithium compound is a butyl lithium compound such as n-butyl lithium, t-butyl lithium, and/or sec-butyl lithium. In particular embodiments, sec-butyl lithium is employed.

The Lewis base may include any Lewis base that does not include an active hydrogen atom, where the presence of an active hydrogen atom is determined by the Zerewitinoff test. Exemplary Lewis bases include oxolanyl propanes such as 2,2-bis(2-oxolanyl)propane (also known as 2,2-ditetrahydrofurylpropane), meso-2,2-diterahydrofurylpropane, DL-2,2,-ditetrahdydrofurlypropane, tetramethylethylenediamine, and mixtures thereof, as well as trialkyl amines such as triethyl amine.

The amount of alkyl lithium compound reacted with the polyalkenyl compound may be quantified based upon the molar ratio of lithium to alkenyl groups; that is, equivalents of lithium associated with the alkyl lithium compound (i.e. mole of Li) relative to the equivalents of alkenyl groups within the polyalkenyl compound (e.g. equivalents of isopropenyl groups within 1,3-diisopropenylbenzene. In one or more embodiments, the molar ratio of moles of Li associated with the alkyl lithium to equivalents of alkenyl groups associated with the polyalkenyl compound may be from about 0.05:1 to about 0.95:1, in other embodiments from about 0.2:1 to about 0.75:1, and in other embodiments from about 0.3:1 to about 0.65:1. Where sec-butyl lithium is reacted with 1,3-diisopropenylbenzene, from about 0.1 to about 1.9, or in other embodiments from about 0.4 to about 1.5, and in other embodiments from about 0.6 to about 1.3 moles of sec-butyl lithium is reacted with each mole of 1,3-diisopropenylbenzene.

The synthesis of the initiator takes place within a solvent in which the reactants and the product is at least partially soluble. Useful solvents include, but are not limited to, hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used.

As indicated above, the multisite initiator formed by the foregoing reaction is aged within an appropriate solvent (e.g. within the reaction medium) in the presence of a Lewis base. In one or more embodiments, the Lewis base is present at the introduction of the reactants to the reaction mixture. In other embodiments, the Lewis base is introduced after synthesis of the multisite initiator and aging takes place after introduction of the Lewis base.

The amount of Lewis base introduced to the reaction mixture may be quantified based upon the moles of Lewis base (e.g. 2,2-ditetrahydrofurylpropane) relative to the moles of lithium associated with the alkyl lithium compound (i.e. molar ratio of moles Lewis base to moles of lithium). In one or more embodiments, the molar ratio of moles of Lewis base introduced to the reaction medium to moles of lithium introduced with the alkyl lithium compound is from about 0.05:1 to about 1:1, in other embodiments from about 0.1:1 to about 0.6:1, and in other embodiments from about 0.2:1 to about 0.45:1.

In one or more embodiments, aging of the initiator takes place under an inert atmosphere at atmospheric conditions at a temperature of from about 0 to about 150° C., in other embodiments from about 25 to about 100° C., and in other embodiments from about 35 to about 60° C. In one or more embodiments, the initiator is aged for greater than 1 minute, in other embodiments greater than 5 minutes, in other embodiments greater than 12 minutes, and in other embodiments greater than 20 minutes before introducing the initiator to the monomer to be polymerized. In one or more embodiments, the initiator is aged for from about 1 to about 60 minutes, in other embodiments from about 5 to about 50 minutes, and in other embodiments from about 12 to about 45 minutes before introducing the initiator to the monomer to be polymerized. The appropriate aging time is temperature dependent; that is, the time necessary to age the initiator decreases with increased temperature. Likewise, the maximum amount of aging decreases with temperature. It should also be appreciated that the temperature dependence of the aging process may allow for longer storage times at cold temperatures. For example, it is believed that the initiator (i.e. the combination of the polyalkenyl compound and the alkyl lithium) can be stored for periods of, for example, 24 hours at temperatures below 0° C.

### Polymerization Reaction

The multisite initiator as prepared above, and optionally aged, is combined with monomer to be polymerized, together with a solvent and potassium alkoxide, to form a polymerization mixture in which the monomer and resulting branched polymer are at least partially soluble. In one or more embodiments, the initiator and potassium alkoxide are also at least partially soluble within the polymerization mixture.

Generally speaking, the polymerization of monomer by the initiator proceeds by anionic polymerization techniques. The preparation of polymer by employing anionic polymerization techniques is generally known. The key mechanistic features of anionic polymerization have been described in books (e.g., Hsieh, H. L.; Quirk, R. P. Anionic Polymerization: Principles and Practical Applications; Marcel Dekker: New York, 1996) and review articles (e.g., Hadjichristidis, N.; Pitsikalis, M.; Pispas, S.; Iatrou, H.; Chem. Rev. 2001, 101 (12), 3747-3792). Anionic initiators may advantageously produce polymer having reactive chain ends (e.g., living polymers) that, prior to quenching, are capable of reacting with additional monomers for further chain growth or reacting with certain functionalizing agents to give functionalized polymers. The polymers having reactive polymer chain ends may simply be referred to as reactive polymers. As those skilled in the art appreciate, these reactive polymers include a reactive chain end, which is believed to be ionic, at which a reaction between a functionalizing agent and the reactive chain end of the polymer can take place, which thereby imparts a functionality or functional group to the polymer chain end, or which may couple multiple polymers together.

The polymerization mixture can be formed by introducing the various constituents in any order. For example, in one or more embodiments, the monomer, and solvent can first be combined, and then the potassium alkoxide can be added to the mixture of solvent and monomer, and then the aged initiator can be introduced to the mixture. In one or more embodiments, the initiator and the potassium alkoxide are combined after aging. In other embodiments, the initiator (i.e. the polyalkenyl compound and the alkyl lithium) is combined with the potassium alkoxide and then aged.

### Monomer to be Polymerized

The monomer that can be anionically polymerized to form these polymers include conjugated diene monomer, which may optionally be copolymerized with other monomers such as vinyl-substituted aromatic monomer. Examples of conjugated diene monomer include 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, and 2,4-hexadiene. Mixtures of two or more conjugated dienes may also be utilized in copolymerization. Examples of monomer copolymerizable with conjugated diene monomer include vinyl-substituted aromatic compounds such as styrene, p-methylstyrene, α-methylstyrene, and vinylnaphthalene.

The amount of the initiator to be employed may depend on the interplay of various factors such as the type of initiator employed, the purity of the ingredients, the polymerization temperature, the polymerization rate and conversion desired, the molecular weight desired, and many other factors. In one or more embodiments, the amount of initiator employed may be expressed as the mmols of initiator per weight of monomer. In one or more embodiments, the amount of initiator introduced to the polymerization mixture is from about 0.1 to about 100 mmol, or in other embodiments from about 0.2 to about 50 mmol, or in other embodiments from about 0.3 to about 15 mmol of the initiator per 100 gram of monomer within the polymerization mixture (i.e. monomer to be polymerized).

### Potassium Alkoxide

In one or more embodiments, the potassium alkoxide is at least partially soluble in the polymerization mixture, where at least partially soluble refers to a degree of solubility or more where the potassium alkoxide is not visible without magnification within the mixture.

In one or more embodiments, the potassium alkoxide is defined by the formula R—O—K, where R is a monovalent organic group. For example, R may be a hydrocarbyl group such as, but not limited to, alkyl, cycloalkyl, alkenyl, cycloalkenyl, aryl, allyl, aralkyl, alkaryl, or alkynyl groups. In one or more embodiments, the cycloalkyl, cycloalkenyl, and aryl groups are non-heterocyclic groups. In one or more embodiments, the hydrocarbyl group may include from about 2 to about 20, or in other embodiments from about 4 to about 16 carbon atoms. In one or more embodiments, hydrocarbyl groups may include substituted hydrocarbyl groups, which refer to hydrocarbyl groups in which one or more hydrogen atoms have been replaced by a substituent such as a hydrocarbyl group. In one or more embodiments, these groups may include from one, or the appropriate minimum number of carbon atoms to form the group, to about 20 carbon atoms. In one or more embodiments, the substituents forming substituted hydrocarbyl groups are non-heterocyclic groups. In one or more embodiments, the hydrocarbyl groups may or may not contain heteroatoms.

Exemplary potassium alkoxide compounds that are useful in the practice of this invention include potassium tert-amylate and potassium tert-butoxide.

As indicated above, aspects of the invention are based on the use of threshold amounts of potassium alkoxide to achieve an advantageous amount of branching. This amount of potassium alkoxide can be quantified relative to the amount of lithium introduced to the polymerization system as part of the initiator. In one or more embodiments, the amount of potassium alkoxide introduced to the system is quantified as a molar ratio of the moles of potassium associated with the potassium alkoxide to the moles of lithium associated with the initiator. In one or more embodiments, the molar ratio of potassium to lithium within the polymerization system (i.e. moles of K to moles of Li) is greater than 0.150:1, in other embodiments greater than 0.200:1, in other embodiments greater than 0.225:1, and in other embodiments greater than 0.250:1. In these or other embodiments, the molar ratio of potassium to lithium within the polymerization system is from about 0.150:1 to about 0.700:1, in other embodiments from about 0.170:1 to about 0.550:1, in other embodiments from about 0.200:1 to about 0.500:1, in other embodiments from about 0.225:1 to about 0.450:1, and in other embodiments from about 0.250:1 to about 0.350:1.

### Solvent for Polymerization Mixture

In one or more embodiments, suitable solvents include those organic compounds that will not undergo polymerization or incorporation into propagating polymer chains during the polymerization of monomer in the presence of catalyst. In one or more embodiments, these organic species are liquid at ambient temperature and pressure. In one or more embodiments, these organic solvents are inert to the catalyst. Exemplary organic solvents include hydrocarbons with a low or relatively low boiling point such as aromatic hydrocarbons, aliphatic hydrocarbons, and cycloaliphatic hydrocarbons. Non-limiting examples of aromatic hydrocarbons include benzene, toluene, xylenes, ethylbenzene, diethylbenzene, and mesitylene. Non-limiting examples of aliphatic hydrocarbons include n-pentane, n-hexane, n-heptane, n-octane, n-nonane, n-decane, isopentane, isohexanes, isopentanes, isooctanes, 2,2-dimethylbutane, petroleum ether, kerosene, and petroleum spirits. And, non-limiting examples of cycloaliphatic hydrocarbons include cyclopentane, cyclohexane, methylcyclopentane, and methylcyclohexane. Mixtures of the above hydrocarbons may also be used. The low-boiling hydrocarbon solvents are typically separated from the polymer upon completion of the polymerization. Other examples of organic solvents include high-boiling hydrocarbons of high molecular weights, such as paraffinic oil, aromatic oil, or other hydrocarbon oils that are commonly used to oil-extend polymers. Since these hydrocarbons are non-volatile, they typically do not require separation and remain incorporated in the polymer.

### Modifier

The polymerization reaction may be conducted in the presence of a modifier, which may also be referred to as a polar coordinator or a vinyl modifier. As those skilled in the art appreciate, these compounds may serve multiple purposes within the polymerization. For example, they can assist in randomizing comonomer throughout the polymer chain; they can also modify the vinyl content of the mer units deriving from dienes. Compounds useful as modifiers include those having an oxygen or nitrogen heteroatom and a non-bonded pair of electrons. Examples include linear and cyclic oligomeric oxolanyl alkanes; dialkyl ethers of mono and oligo alkylene glycols (also known as glyme ethers); “crown” ethers; tertiary amines; linear THF oligomers; and the like. Linear and cyclic oligomeric oxolanyl alkanes are described in U.S. Pat. Nos. 4,429,091 and 9,868,795, which are incorporated herein by reference. Specific examples of compounds useful as randomizers include 2,2-bis(2-oxolanyl)propane (also known as 2,2-ditetrahydrofurylpropane), meso-2,2-diterahydrofurylpropane, DL-2,2,-ditetrahdydrofurlypropane, and mixtures thereof, 1,2-dimethoxyethane, N,N,N′,N′-tetramethylethylenediamine (TMEDA), tetrahydrofuran (THF), 1,2-dipiperidylethane, dipiperidylmethane, hexamethylphosphoramide, N—N′-dimethylpiperazine, diazabicyclooctane, dimethyl ether, diethyl ether, tri-n-butylamine, and mixtures thereof. In other embodiments, potassium alkoxides can be used to randomize the styrene distribution. In one or more embodiments, a randomizer other than a potassium alkoxide is employed. In other embodiments, potassium alkoxide is the only randomizer present within the polymerization mixture.

The amount of randomizer to be employed may depend on various factors such as the desired microstructure of the polymer, the ratio of monomer to comonomer, the polymerization temperature, as well as the nature of the specific randomizer employed.

### Polymerization Conditions and Techniques

The anionic initiator and the randomizer can be introduced to the polymerization system by various methods. In one or more embodiments, the anionic initiator and the randomizer may be added separately to the monomer to be polymerized in either a stepwise or simultaneous manner.

As indicated above, polymerization of conjugated diene monomer, together with monomer copolymerizable with the conjugated diene monomer, in the presence of an effective amount of initiator, produces a reactive polymer. The introduction of the initiator, the conjugated diene monomer, the comonomer, and the solvent forms a polymerization mixture in which the reactive polymer is formed. Polymerization within a solvent produces a polymerization mixture in which the polymer product is dissolved or suspended in the solvent. This polymerization mixture may be referred to as a polymer cement.

In one or more embodiments, the polymerization may be conducted in any conventional polymerization vessel known in the art. For example, the polymerization can be conducted in a conventional stirred-tank reactor. In one or more embodiments, all of the ingredients used for the polymerization can be combined within a single vessel (e.g., a conventional stirred-tank reactor), and all steps of the polymerization process can be conducted within this vessel. In other embodiments, two or more of the ingredients can be pre-combined in one vessel and then transferred to another vessel where the polymerization of monomer (or at least a major portion thereof) may be conducted. Because various embodiments of the present invention include the use of multiple reactors or reaction zones, the vessel (e.g., tank reactor) in which the polymerization is conducted may be referred to as a first vessel or first reaction zone.

The polymerization can be carried out as a batch process, a continuous process, or a semi-continuous process. In the semi-continuous process, the monomer is intermittently charged as needed to replace that monomer already polymerized. In one or more embodiments, the heat of polymerization may be removed by external cooling by a thermally controlled reactor jacket, internal cooling by evaporation and condensation of the monomer through the use of a reflux condenser connected to the reactor, or a combination of the two methods. Also, conditions may be controlled to conduct the polymerization under a pressure of from about 0.1 atmospheres to 50 atmospheres, in other embodiments from about 0.5 atmosphere to about 20 atmosphere, and in other embodiments from about 1 atmosphere to about 10 atmospheres. In one or more embodiments, the pressures at which the polymerization may be carried out include those that ensure that the majority of the monomer is in the liquid phase. In these or other embodiments, the polymerization mixture may be maintained under anaerobic conditions.

In one or more embodiments, the conditions under which the polymerization proceeds may be controlled to maintain the peak polymerization temperature of the polymerization mixture at greater than 30° C., in other embodiments greater than 50° C., and in other embodiments greater than 70° C. In these or other embodiments, the conditions under which the polymerization proceeds may be controlled to maintain the peak polymerization temperature of the polymerization mixture at less than 120° C., in other embodiments less than 110° C., and in other embodiments less than 100° C. In one or more embodiments, the conditions under which the polymerization proceeds may be controlled to maintain the temperature of the polymerization mixture within a range from about −10° C. to about 200° C., in other embodiments from about 0° C. to about 150° C., and in other embodiments from about 20° C. to about 110° C.

### Polymer Functionalization

As indicated above, since the branched polymers are prepared by anionic polymerization techniques, the branches are reactive and capable of being modified, which may also be referred to as functionalized, to provide a multi-functional branched polymer. That is, the reactive end of the polymer is modified, which may also be referred to as functionalized, by introducing a functionalizing agent to the polymerization mixture. It is believed that the polymer chain ends react with the functionalizing agent (which may also be referred to as a modifying agent) to provide a residue of the functionalizing agent at the end of the polymer chain. Accordingly, the reaction between the branched polymer and the functionalizing agent produces a branched polymer composition wherein two or more of the polymer branches of any branched polymer molecule include a terminal group deriving from the functionalizing agent. It should be appreciated that the reaction between the functionalizing agent and the reactive polymer branch can also result in polymer coupling of two or more branched polymers. In either event, branched polymers bearing a chain-end functional group and branched polymers coupled with the residue of the functionalizing agent will both be referred to as modified or functionalized branched polymers unless otherwise designated.

### Functionalizing Agents

Useful functionalizing agents include those functionalizing agents conventionally employed in the art. As the skilled person appreciates, the functionalizing agent imparts a terminal functionality that can be reactive or interactive with other polymer chains (propagating and/or non-propagating) or with other materials in a rubber compound such as particulate reinforcing fillers (e.g. carbon black or silica). As described above, enhanced interactivity between a polymer and particulate fillers in rubber compounds improves the mechanical and dynamic properties of resulting vulcanizates. For example, certain functionalizing agents can impart a terminal functionality that includes one or more heteroatoms. In one or more embodiments, the functionalizing agent may produce a functionalized polymer that can be used in rubber compositions from which vulcanizates can be provided, and these vulcanizates can possess high temperature (e.g., 50° C.) hysteresis losses that are less than those possessed by vulcanizates prepared from similar rubber compounds that do not include the functionalized polymers. Reductions in high temperature hysteresis loss can be at least 5%, sometimes at least 10%, and occasionally at least 15%.

Exemplary types of compounds that can be used to end-functionalize the reactive branched polymers of this invention include imines, amines, hydrocarbyloxy silanes, amine-containing hydrocarbyloxy silanes, halogenated organics, trialkyl tin compounds, carbon dioxide, benzophenones, benzaldehydes, imidazolidones, pyrrolidinones, carbodiimides, ureas, isocyanates, and Schiff bases. It should also be appreciated that two or more different species of functionalizing agent can be employed in practicing the present invention.

### Hydrocarbyloxy Silane Functionalizing Agents

In one or more embodiments, hydrocarbyloxy silane functionalizing agents may be defined by the formula:

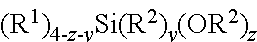

where R¹ is a halogen atom or a monovalent organic group, each R² is a monovalent organic group, z is an integer from 1 to 4, and y is an integer from 0 to 2. In one embodiment, the halogen atom is chlorine.

In one or more embodiments, the monovalent organic groups include hydrocarbyl groups such as, but not limited to, alkyl, cycloalkyl, alkenyl, cycloalkenyl, aryl, allyl, aralkyl, alkaryl, or alkynyl groups. Hydrocarbyl groups also include substituted hydrocarbyl groups, which refer to hydrocarbyl groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkyl, cycloalkenyl, and aryl groups are non-heterocyclic groups. In these or other embodiments, the substituents forming substituted hydrocarbyl groups are non-heterocyclic groups.

Suitable examples of siloxane terminating agents include tetraalkoxysilanes, alkylalkoxysilanes, arylalkoxysilanes, alkenylalkoxysilanes, and haloalkoxysilanes.

Examples of tetraalkoxysilane compounds include tetramethyl orthosilicate, tetraethyl orthosilicate, tetrapropyl orthosilicate, tetrabutyl orthosilicate, tetra(2-ethylhexyl) orthosilicate, tetraphenyl orthosilicate, and tetratoluyloxysilane.

Examples of alkylalkoxysilane compounds include methyltrimethoxysilane, methyltriethoxysilane, methyltri-n-propoxysilane, methyltri-n-butoxysilane, methyltriphenoxysilane, ethyltrimethoxysilane, ethyltriethoxysilane, ethyltri-n-propoxysilane, ethyltri-n-butoxysilane, ethyltriphenoxysilane, dimethyldimethoxysilane, dimethyldiethoxysilane, dimethyldi-n-propoxysilane, dimethyldi-n-butoxysilane, dimethyldiphenoxysilane, diethyldimethoxysilane, and diphenyldimethoxysilane.

Examples of arylalkoxysilane compounds include phenyltrimethoxysilane, phenyltriethoxysilane, phenyltri-n-propoxysilane, phenyltri-n-butoxysilane, and phenyltriphenoxysilane.

Examples of alkenylalkoxysilane compounds include vinyltrimethoxysilane, vinyltriethoxysilane, vinyltri-n-propoxysilane, vinyltri-n-butoxysilane, vinyltriphenoxysilane, allyltrimethoxysilane, octenyltrimethoxysilane, and divinyldimethoxysilane.

Examples of haloalkoxysilane compounds include trimethoxychlorosilane, triethoxychlorosilane, tri-n-propoxychlorosilane, tri-n-butoxychlorosilane, dimethoxydichlorosilane, diethoxydichlorosilane, di-n-triphenoxychlorosilane, diphenoxydichlorosilane, methoxytrichlorosilane, propoxydichlorosilane, n-propoxytrichlorosilane, ethoxytrichlorosilane, phenoxytrichlorosilane, tri-n-propoxybromosilane, trimethoxybromosilane, triethoxybromosilane, triphenoxybromosilane, dimethoxydibromosilane, diethoxydibromosilane, di-n-diphenoxydibromosilane, methoxytribromosilane, propoxydibromosilane, n-propoxytribromosilane, phenoxytribromosilane, ethoxytribromosilane, trimethoxyiodosilane, triethoxyiodosilane, tri-n-propoxyiodosilane, triphenoxyiodosilane, dimethoxydiiodosilane, di-n-propoxydiiodosilane, diphenoxydiiodosilane, methoxytriiodosilane, ethoxytriiodosilane, n-propoxytriiodosilane, and phenoxytriiodosilane.

Techniques for preparing functionalized polymers by using hydrocarbyloxy silane compounds are set forth in U.S. Pat. Nos. 3,244,664; 6,008,295; 6,228,908; and 4,185,042, which are incorporated herein by reference.

In one or more embodiments, hydrocarbyloxy silane functionalizing agents is an imino-containing hydrocarbyloxy silane that may be defined by the formula:

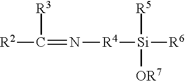

where R², R³, and R⁷ are monovalent organic groups, R⁴ is a divalent organic group, and where R⁵ and R⁶ are each independently hydrocarbyloxy groups or hydrocarbyl groups.

In one or more embodiments, the divalent organic group is a hydrocarbylene groups such as, but not limited to, alkylene, cycloalkylene, alkenylene, cycloalkenylene, alkynylene, cycloalkynylene, or arylene groups. Hydrocarbylene groups include substituted hydrocarbylene groups, which refer to hydrocarbylene groups in which one or more hydrogen atoms have been replaced by a substituent such as a hydrocarbyl group. In one or more embodiments, these groups may include from one, or the appropriate minimum number of carbon atoms to form the group, to about 20 carbon atoms. These groups may or may not contain heteroatoms. Suitable heteroatoms include, but not limited to, nitrogen, boron, oxygen, silicon, sulfur, tin, and phosphorus atoms. In one or more embodiments, the cycloalkylene, cycloalkenylene, and arylene groups are non-heterocyclic groups. In these or other embodiments, the substituents forming substituted hydrocarbylene groups are non-heterocyclic groups.

Examples of these imino-containing hydrocarbyloxy silane compounds include triethoxy compounds such as, but are not limited to, N-(1,3-dimethylbutylidene)-3-(triethoxysilyl)-1-propaneamine, N-(1-methylethylidene)-3-(triethoxysilyl)-1-propaneamine, N-ethylidene-3-(triethoxysilyl)-1-propaneamine, N-(1-methylpropylidene)-3-(triethoxysilyl)-1-propaneamine, N-(4-N,N-dimethylaminobenzylidene)-3-(triethoxysilyl)-1-propaneamine, and N-(cyclohexylidene)-3-(triethoxysilyl)-1-propaneamine. Other examples include trimethoxy compounds such as, but not limited to, N-(1,3-dimethylbutylidene)-3-(trimethoxysilyl)-1-propaneamine, N-(1-methylethylidene)-3-(trimethoxysilyl)-1-propaneamine, N-ethylidene-3-(trimethoxysilyl)-1-propaneamine, N-(1-methylpropylidene)-3-(trimethoxysilyl)-1-propaneamine, N-(4-N,N-dimethylaminobenzylidene)-3-(trimethoxysilyl)-1-propaneamine, and N-(cyclohexylidene)-3-(trimethoxysilyl)-1-propaneamine. Other examples include methyldiethoxy compounds such as, but not limited to, N-(1,3-dimethylbutylidene)-3-(methyldiethoxysilyl)-1-propaneamine, N-(1-methylethylidene)-3-(methyldiethoxysilyl)-1-propaneamine, N-ethylidene-3-(methyldiethoxysilyl)-1-propaneamine, N-(1-methylpropylidene)-3-(methyldiethoxysilyl)-1-propaneamine, N-(4-N,N-dimethylaminobenzylidene)-3-(methyldiethoxysilyl)-1-propaneamine, and N-(cyclohexylidene)-3-(methyldiethoxysilyl)-1-propaneamine. Other examples include ethyldimethoxy compounds such as, but not limited to, N-(1,3-dimethylbutylidene)-3-(ethyldimethoxysilyl)-1-propaneamine, N-(1-methylethylidene)-3-(ethyldimethoxysilyl)-1-propaneamine, N-ethylidene-3-(ethyldimethoxysilyl)-1-propaneamine, N-(1-methylpropylidene)-3-(ethyldimethoxysilyl)-1-propaneamine, N-(4-N,N-dimethylaminobenzylidene)-3-(ethyldimethoxysilyl)-1-propaneamine, and N-(cyclohexylidene)-3-(ethyldimethoxysilyl)-1-propaneamine.

Techniques for preparing functionalized polymers by using imine-containing hydrocarbyloxy compounds are disclosed in U.S. Publication Nos. 2005/0009979; 2010/0113683; and 2011/0092633, which are incorporated herein by reference.

In one or more embodiments, hydrocarbyloxy silane functionalizing agents is a hydrocarbyloxy silane defined by the formula:

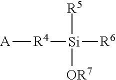

where R⁴ is a divalent organic group, where R⁵ and R⁶ are each independently hydrocarbyloxy groups or hydrocarbyl groups, R⁵ is a monovalent organic group, and A is selected from the group consisting of carboxylic ester, cyclic tertiary amine, non-cyclic tertiary amine, pyridine, silazane, and sulfide groups.

Examples of hydrocarbyloxy silane compounds including a carboxylic ester group include, but are not limited to, 3-methacryloyloxypropyltriethoxysilane, 3-methacryloyloxypropyltrimethoxysilane, 3-methacryloyloxypropylmethyldiethoxysilane, and 3-methacryloyloxypropyltriisopropoxysilane.

Examples of hydrocarbyloxy silane compounds including a cyclic tertiary amine group include, but are not limited to, 3-(1-hexamethyleneimino)propyltriethoxysilane, 3-(1-hexamethyleneimino)propyltrimethoxysilane, (1-hexamethyleneimino)methyltriethoxysilane, (1-hexamethyleneimino)methyltrimethoxysilane, 2-(1-hexamethyleneimino)ethyltriethoxysilane, 3-(1-hexamethyleneimino)ethyltrimethoxysilane, 3-(1-pyrrolidinyl)propyltrimethoxysilane, 3-(1-pyrrolidinyl)propyltriethoxysilane, 3-(1-heptamethyleneimino)propyltriethoxysilane, 3-(1-dodecamethyleneimino)propyltriethoxysilane, 3-(1-hexamethyleneimino)propyldiethoxyethylsilane, and 3-[10-(triethoxysilyl)decyl]-4-oxazoline

Examples of hydrocarbyloxy silane compounds including a non-cyclic tertiary amine group include, but are not limited to, 3-dimethylaminopropyltriethoxysilane, 3-dimethylaminopropyltrimethoxysilane, 3-diethylaminopropyltrimethoxysilane, 3-diethylaminopropyltriethoxysilane, 2-dimethylaminoethyltriethoxysilane, 2-dimethylaminoethyltrimethoxysilane, 3-dimethylaminopropyldiethoxymethylsilane, 3-diethylaminopropyldiethoxymethylsilane, 3-dimethylaminopropyldimethoxymethylsilane, 3-diethylaminopropyldimethoxymethylsilane, and 3-dibutylaminopropyltriethoxysilane

Examples of hydrocarbyloxy silane compounds including a pyridine group include, but are not limited to, 2-trimethoxysilylethylpyridine.

Examples of hydrocarbyloxy silane compounds including a silazane group include, but are not limited to, N,N-bis(trimethylsilyl)-aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)aminoethyltriethoxysilane, N,N-bis(trimethylsilyl)aminoethylmethyldimethoxysilane, and N,N-bis(trimethylsilyl)aminoethylmethyldiethoxysilane.

Still other specific examples of useful functionalizing agents include trialkyltin halides such as triisobutyltin chloride, as disclosed in U.S. Pat. Nos. 4,519,431; 4,540,744; 4,603,722; 5,248,722; 5,349,024; 5,502,129; and 5,877,336, which are incorporated herein by reference. Examples of useful halogenated organic compounds include cyclic amino compounds such as hexamethyleneimine alkyl chloride, as disclosed in U.S. Pat. Nos. 5,786,441; 5,916,976; and 5,552,473, which are incorporated herein by reference. Additional examples include cyclic sulfur-containing or oxygen containing azaheterocycles such as disclosed in WO 2004/020475; U.S. Publication No. 2006/0178467; and U.S. Pat. No. 6,596,798, which are incorporated herein by reference. Other examples include boron-containing terminators such as disclosed in U.S. Pat. No. 7,598,322, which is incorporated herein by reference. Still other examples include cyclic siloxanes such as hexamethylcyclotrisiloxane, including those disclosed in U.S. Pat. No. 9,920,149, which is incorporated herein by reference. Yet other examples include polydimethylsiloxanes.

### Amount of Functionalization Agent Used

The amount of functionalizing employed in the practice of the present invention can be described with respect to the lithium or metal cation associated with the initiator. In one or more embodiments, the amount of functionalizing agent introduced to the polymerization mixture is greater than 0.70, in other embodiments greater than 0.75, in other embodiments greater than 0.80, in other embodiments greater than 0.85, and in other embodiments greater than 0.90 moles of functionalizing agent per mole of lithium in the initiator. In these or other embodiments, less than 0.99, in other embodiments less than 0.97, and in other embodiments less than 0.95 moles of functionalizing agent per mole of lithium is introduced to the polymerization mixture. In one or more embodiments, from about 0.7 to about 1.0, in other embodiments from about 0.75 to about 0.99, and in other embodiments from about 0.80 to about 0.97 moles of functionalizing agent per mole of lithium is introduced to the polymerization mixture.

### Functionalization Reaction

The reaction between the respective species of functionalizing agents and the polymer can take place by introduction the functionalizing agent sequentially or simultaneously to the reactive polymer.

In one or more embodiments, the reaction between the functionalizing agent and the reactive polymer may take place at a temperature from about 10° C. to about 150° C., and in other embodiments from about 20° C. to about 100° C. The time required for completing the reaction between the functionalizing agent and the reactive polymer depends on various factors such as the type and amount of the initiator used to prepare the reactive polymer, the type and amount of the functionalizing agent, as well as the temperature at which the functionalization reaction is conducted. In one or more embodiments, the reaction between the functionalizing agent and the reactive polymer can be conducted for about 10 to 60 minutes.

In one or more embodiments, the functionalizing agent is introduced to the polymer cement (i.e. polymerization mixture) while the polymer is dissolved or suspended within a solvent. As those skilled in the art appreciate, this solution may be referred to as a polymer cement, or more specifically as a reactive or living polymer cement. In one or more embodiments, the characteristics of the polymer cement, such as its concentration, will be the same or similar to the characteristics of the cement prior to functionalization. The composition including the functionalized polymer and solvent may be referred to as a polymerization mixture; in other words, a polymerization mixture including a functionalized polymer.

In one or more embodiments, modification of the polymer (i.e., introduction of the functionalizing agent to the polymer cement), takes place within the same vessel in which the polymerization was conducted. In other embodiments, modification of the polymer takes place outside of the reaction vessel in which the polymerization takes place. For example, the first and second functionalizing agents can be introduced to the polymerization mixture (i.e. polymer cement) in a downstream vessel or a downstream transfer conduit.

According to one or more embodiments, as a result of the functionalization reaction, greater than 60 mol %, in other embodiments greater than 70 mol %, in other embodiments greater than 80 mol %, in other embodiments greater than 85 mol %, in other embodiments greater than 90 mol %, and in other embodiments greater than 95 mol % of the polymer chains or branches (i.e. a reactive chain of a branched macromolecule) within the polymer cement include a terminal functional group (i.e. the residue of a functionalizing agent). In one or more embodiments, from about 60 to about 100 mol %, in other embodiments from about 70 to about 99 mol %, in other embodiments from about 80 to about 98 mol %, and in other embodiments from about 90 to about 97 mol % of the polymer chains or branches within the polymer composition include the terminal functional group.

### Post Polymerization & Functionalization

### Polymer Stabilization

In one or more embodiments, following modification, the modified polymer (i.e. the multi-functionalized branched polymer) may optionally be stabilized. That is, the modified polymer may be stabilized by introducing a stabilizing agent to the polymerization mixture including the modified polymer. It is believed that the stabilizing agent reacts with certain terminal functional groups (e.g. a hydrocarbyloxy substituent), and it is believed that this reaction may take place at the introduction of the two molecules or after aging of the composition.

In one or more embodiments, stabilizing agents known in the art may be used. For example, the stabilizing agents may include alkylalkoxy silanes as disclosed in U.S. Pat. No. 6,255,404, which is incorporated herein by reference. Exemplary alkylalkoxy silanes include octyltriethoxy silane. In other embodiments, the stabilizing agent may include long-chain alcohols as disclosed in U.S. Pat. No. 6,279,632, which is incorporated herein by reference. Exemplary long chain alcohols include sorbitan stearate or sorbitan momoleate. In still other embodiments, the polymers may be stabilized by treatment with an alkylalkoxy silane followed by treatment with a silane including a hydrolyzable group that forms an acidic species upon hydrolysis, such as methyltrichlorosilane, as disclosed in U.S. Pat. No. 9,546,237, which is incorporated herein by reference.

In one or more embodiments of this invention, the use of aryl silanols (also known as hydroxy phenyl silanes) is advantageously used as a stabilizing agent. Useful aryl silanols are disclosed in U.S. Pat. No. 9,255,167, which is incorporated herein by reference. Exemplary aryl silanols include, but are not limited to, triphenylsilanol, which is also referred to as hydroxytriphenylsilane, diphenylsilanediol, which is also referred to as dihydroxydiphenylsilane, and phenylsilanetriol, which is also referred to as trihydroxy (phenyl) silane.

In one or more embodiments, the functionalized polymers of this invention may be stabilized by treatment with an aryl silanol (e.g. aryl silane diol or aryl silane triol) contemporaneously or followed by treatment with a silane including a hydrolyzable group that forms an acidic species upon hydrolysis. Silanes including a hydrolyzable group that form an acidic species upon hydrolysis are disclosed in U.S. Pat. No. 9,546,237, which is incorporated herein by reference. In particular embodiments, the functionalized polymers are treated with diphenyl silane diol and trimethyl silyl chloride.

In one or more embodiments, the stabilizing agent is added to the polymer cement after a sufficient time is provided to allow completion of the reaction between the reactive polymer and the functionalizing agent. In one or more embodiments, the stabilizing agent is introduced to the polymer cement after 30 minutes, in other embodiments after 15 minutes, and in other embodiments after 10 minutes from the time that the functionalizing agent is introduced to the polymer cement.

The amount of stabilizing agent (e.g. aryl silanol) employed in the practice of the present invention can be described with respect to the moles of lithium associated with the initiator. In one or more embodiments, greater than 0.5, in other embodiments greater than 1, in other embodiments greater than 2, and in other embodiments greater than 3 moles of stabilizing agent per mole of lithium in the initiator is introduced to the polymerization mixture. In these or other embodiments, less than 8, in other embodiments less than 7, in other embodiments less than 6, in other embodiments less than 5, and in other embodiments less than 4.5 moles of stabilizing agent per mole of lithium is introduced to the polymerization mixture. In one or more embodiments, from about 1 to about 7, in other embodiments from about 2 to about 6, and in other embodiments from about 3 to about 5 moles of stabilizing agent per mole of lithium is introduced to the polymerization mixture.

In other embodiments, the amount of stabilizing agent (e.g. aryl silanol) employed in the practice of the present invention can be described as a molar ratio relative to the moles of functionalizing agent employed. In one or more embodiments, the ratio of the moles of stabilizing agent to the moles of functionalizing agent employed is from about 0.5:1 to about 8:1; in other embodiments from about 1:1 to about 7:1, in other embodiment from about 2:1 to about 6:1, and in other embodiments from about 3:1 to about 5:1. In these or other embodiments, the ratio of the moles of stabilizing agent to the moles of functionalizing agent employed is less than 7:1, in other embodiments less than 6:1, in other embodiments less than 5.5:1, in other embodiments less than 5:1, and in other embodiments less than 4.5:1.

Where two reagents are employed, such as where the polymer is treated with an aryl silanol (e.g. aryl silane diol or aryl silane triol) together with a silane including a hydrolyzable group that forms an acidic species upon hydrolysis (e.g. hydrocarbyl silyl chloride such as trimethyl silyl chloride), the amount of the respective reagents employed may be the same or different. In one or more embodiments, the total amount of stabilizer employed (i.e. both compounds) is, when described as a molar ratio relative to the moles of functionalizing agent, from about 3:1 to about 10:1, in other embodiments from about 4:1 to about 8:1, and in other embodiments from about 5:1 to about 7:1. In these or other embodiments, the molar ratio of the aryl silanol to the silane including a hydrolyzable group that forms an acidic species upon hydrolysis is from about 0.5:1 to about 4:1, in other embodiments from about 1:1 to about 3:1, and in other embodiments from about 1.5:1 to about 2.5:1.

In one or more embodiments, the stabilization of the polymer (i.e., introduction of the stabilizing agent) takes place within the same vessel in which the polymerization took place. In these embodiments, this will include the same vessel in which the modification took place. In other embodiments, stabilization of the polymer (i.e., introduction of the stabilizing agent) takes place outside of the vessel in which the polymerization took place. Likewise, in one or more embodiments, stabilization of the polymer takes place outside of the vessel in which the modification of the polymer took place. For example, in one or more embodiments, the stabilizing agent can be added to the polymerization mixture (i.e., polymer cement) in a vessel or transfer line that is downstream of the vessel in which the polymerization took place and that is downstream of the vessel in which the polymer modification took place. For purposes of this specification, relative to the polymerization vessel, the vessel or conduit in which the stabilizing agent is introduced may be referred to as a second vessel or second reaction zone. In other embodiments, the stabilizing agent may be introduced to the polymer while the polymer is suspended or dissolved within monomer.

### Condensation Accelerator

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, a condensation accelerator can be added to the polymerization mixture. Useful condensation accelerators include tin and/or titanium carboxylates and tin and/or titanium alkoxides. One specific example is titanium 2-ethylhexyl oxide. Useful condensation catalysts and their use are disclosed in U.S. Publication No. 2005/0159554 (Patent No. U.S. Pat. No. 7,683,151), which is incorporated herein by reference. In other embodiments, an organic acid can be used as a condensation accelerator. Useful types of organic acids include aliphatic, cycloaliphatic and aromatic monocarboxylic, dicarboxylic, tricarboxylic and tetracarboxylic acids. Specific examples of useful organic acids include, but are not limited to, acetic acid, propionic acid, butyric acid, hexanoic acid, 2-methylhexanoic acid, 2-ethylhexanoic acid, cyclohexanoic acid and benzoic acid.

The amount of condensation accelerator employed in the practice of the present invention can be described with respect to the moles of lithium associated with the initiator. In one or more embodiments, the moles of condensation accelerator per mole of lithium is greater than 1.0, in other embodiments greater than 1.5, and in other embodiments greater than 1.8 moles of condensation accelerator per mole of lithium in the initiator. In these or other embodiments, less than 4.0, in other embodiments less than 3.3, and in other embodiments less than 3.0 moles of condensation accelerator per mole of lithium is introduced to the polymerization mixture. In one or more embodiments, from about 1.0 to about 4.0, in other embodiments from about 1.5 to about 3.3, and in other embodiments from about 1.8 to about 3.0 moles of condensation accelerator per mole of lithium is introduced to the polymerization mixture.

### Antioxidant

In one or more embodiments, after the introduction of the functionalizing agent to the reactive polymer, optionally after the addition of a quenching agent and/or antioxidant, optionally after or together with the stabilizing agent, and optionally after recovery or isolation of the functionalized polymer, an antioxidant can be added to the polymerization mixture. Exemplary antioxidants include 2,6-di-tert-butyl-4-methylphenol.

In one or more embodiments, after formation of the polymer, a processing aid and other optional additives such as oil can be added to the polymer cement.

### Optional Quenching

In one or more embodiments, after the polymerization reaction, or after the reaction between the reactive polymer and the functionalizing agent has been accomplished or completed, a quenching agent can be added to the polymerization mixture in order to inactivate any residual reactive polymer chains and the catalyst or catalyst components. The quenching agent may include a protic compound, which includes, but is not limited to, an alcohol, a carboxylic acid, an inorganic acid, water, or a mixture thereof. The amount of quenching agent employed may be in the range of 0.5 to 10 moles of quenching agent per mole of lithium used to initiate the polymerization.

### Polymer Desolventization

Following polymerization and/or polymer modification, optional stabilization, optional introduction of a condensation accelerator and/or introduction of an antioxidant, the polymer product can be separated from the solvent, which may be referred to as desolventization. In other words, as described above, the polymers are synthesized in an organic solvent, and during the step of desolventization, the organic solvent is separated from the resulting polymer.

In particular embodiments, desolventization includes hot water and/or steam coagulation. For example, the polymerization mixture, which includes the blend of modified polymers, can be combined with a steam or hot water stream. The heat associated with the steam or hot water stream volatilizes the solvent and any unreacted monomer. The polymer product is then dispersed within an aqueous phase in, for example, the form of polymer crumb. The nature and size of the polymer crumb can generally be manipulated by the introduction of mechanical energy (e.g., in the form of mixers).

In one or more embodiments, the polymer crumb is temporarily stored as a crumb dispersion within the water until subsequent drying steps, which are described below. The crumb dispersion is generally a mixture of polymer particles or crumb and water. The polymer particles, which may also be referred to as coagulated polymer, are generally on the macroscale and have at least on dimension that is greater than one mm. This crumb dispersion may be contained within a tank, such as a conventional reactor tank such as a continuously stirred tank reactor.

In one or more embodiments, the polymer crumb can be further processed to remove residual solvent and dry the polymer (i.e., separate the polymer from the water). In practicing the present invention, the polymer can be dried by using conventional techniques, which may include one or more of filtering, pressing, and heating. Following desolventization and drying, the volatile content of the dried polymer can be below 2.0%, in other embodiments below 1.0%, and in other embodiments below 0.5% by weight of the polymer.

In other embodiments, the polymer product can be desolventized by employing devolatilizers, which are extruder-type devices that can operate in conjunction with heat and/or vacuum. In yet other embodiments, the polymerization mixture can be directly drum dried.

Regardless of the methods used to desolventize and dry the polymer, the finished polymer product may be referred to as a dried polymer. Using conventional techniques, the dried polymer can be molded or otherwise manipulated into a bale.

### Characteristic of Branched Polymers

The branched polymers may be characterized by their molecular weight, and in particular their weight average molecular weight (Mw). As those skilled in the art will appreciate, the weight average molecular weight of branched polymers can be determined by using gel permeation chromatography (GPC) equipped with a multi-angle light scattering (MALLS) detector.

In one or more embodiments, the unfunctional branched polymers have an Mw, which may also be referred to as the base Mw, of greater than 250 kg/mol, in other embodiments greater than 350 kg/mol, and in other embodiments greater than 450 kg/mol. In these or other embodiments, the branched polymer shave an Mw of less 850 kg/mol, in other embodiments less than 800 kg/mol, and in other embodiments less than 750 kg/mol. In one or more embodiments, the branched polymers have an Mw of from about 350 to about 850 kg/mol, in other embodiments from about 450 to about 800 kg/mol, and in other embodiments from about 550 to about 750 kg/mol.

In one or more embodiments, the functional branched polymers have an Mw of greater than 350 kg/mol, in other embodiments greater than 450 kg/mol, and in other embodiments greater than 550 kg/mol. In these or other embodiments, the branched polymers have an Mw of less 1300 kg/mol, in other embodiments less than 1200 kg/mol, and in other embodiments less than 1100 kg/mol. In one or more embodiments, the branched polymers have an Mw of from about 350 to about 1300 kg/mol, in other embodiments from about 450 to about 1200 kg/mol, and in other embodiments from about 550 to about 1200 kg/mol.

The branched polymers produced according to aspects of the present invention may be characterized by vinyl content, which may be described as the number of unsaturations in the 1,2-microstructure relative to the total unsaturations within the polymer chain. As the skilled person will appreciate, vinyl content can be determined by NMR analysis at 400 MHz using CDCl₃ as a solvent. In one or more embodiments, the branched polymers include greater than 10%, in other embodiments greater than 20%, and in other embodiments greater than 35% vinyl. In these or other embodiments, the branched polymers include less than 80%, in other embodiments less than 60%, and in other embodiments less than 46%. In one or more embodiments, the branched polymers include from about 10 to about 80%, in other embodiments from about 20 to about 60%, and in other embodiments from about 35 to about 46% vinyl.

The branched polymers produced according to aspects of the present invention may be characterized by bound styrene content (i.e. the amount of styrene incorporated in the polymer chains), which refers to the weight percent vinyl aromatic monomer incorporated into polydiene copolymers. As the skilled person appreciates, bound styrene can be determined with reference to the relative weight of vinyl monomer included into the polymerization mixture relative to the diene monomer. Alternatively, bound styrene can be determined by NMR analysis at 400 MHz using CDCl₃ as a solvent. In one or more embodiments, the branched polymers include greater than 20 wt %, in other embodiments greater than 25 wt %, and in other embodiments greater than 30 wt % bound styrene. In these or other embodiments, the reactive copolymers include less than 60 wt %, in other embodiments less than 55 wt %, and in other embodiments less than 50 wt % bound styrene. In one or more embodiments, the reactive copolymers include from about 20 to about 60 wt %, in other embodiments from about 25 to about 55 wt %, and in other embodiments from about 30 to about 50 wt % bound styrene.

The un-functionalized branched polymers produced according to aspects of the present invention may be characterized by T₈₀, which is determined according to ASTM D 1646-19A by using a Mooney viscometer (e.g. Agilent Technologies) with a large rotor at 100° C. with a 4 minute run time after 1 minute of preheating (i.e. ML ₁₊₄ @ 100° C.). In one or more embodiments, the un-functionalized branched polymers have a T₈₀ of greater than 2, in other embodiments greater than 4, in other embodiments greater than 6, and in other embodiments greater than 8 minutes. In one or more embodiments, the un-functionalized branched polymers have a T₈₀ of from about 2 to about 15, in other embodiments from about 4 to about 14, and in other embodiments from about 6 to about 12 minutes.

The branched polymers produced according to aspects of the present invention may be characterized by Mooney viscosity, which is determined according to by using a Monsanto Mooney viscometer with a large rotor at 100° C. with a 4 minute run time after 1 minute of preheating (i.e. ML ₁₊₄ @ 100° C.). In one or more embodiments, the branched polymers have a Mooney viscosity of greater than 20, in other embodiments greater than 30, and in other embodiments greater than 40. In these or other embodiments, the branched polymers have a Mooney viscosity of less than 80, in other embodiments less than 70, and in other embodiments less than 60. In one or more embodiments, the branched polymers have a Mooney viscosity of from about 20 to about 80, in other embodiments from about 30 to about 70, and in other embodiments from about 40 to about 60.

The branched polymers produced according to aspects of the present invention may be characterized by Tg, which is determined according to ASTM E1356-08 by using differential scanning calorimetry (DSC) techniques. In one or more embodiments of less than −20, in other embodiments less than −30, and in other embodiments less than −40° C. In one or more embodiments, the branched polymers have a Tg of from about −65 to about −30, in other embodiments from about −60 to about −30, and in other embodiments from about-50 to about −40° C.

### INDUSTRIAL APPLICABILITY

In one or more embodiments, the branched polymers of the invention may be used in formulating vulcanizable rubber composition that may, for example, be useful in the preparation of tire components. Rubber compounding techniques and the additives employed therein are generally disclosed in The Compounding and Vulcanization of Rubber, in Rubber Technology (2nd Ed. 1973).

Generally speaking, these vulcanizable rubber compositions include a vulcanizable rubber component, reinforcing filler, and a curative or curative system. These compositions may also optionally include metal activators, resins, and processing oils, as well the various ingredients that may be conventionally included in these vulcanizable rubber compositions.

In one or more embodiments, the branched polymers of this invention may form all or part of the rubber component of the vulcanizable compositions. That is, the rubber component may include other vulcanizable rubbers, which may also be referred to as elastomeric polymers or simply elastomers.

The rubber compositions can be prepared by using the branched polymers of this invention alone or together with other elastomers (i.e., polymers that can be vulcanized to form compositions possessing rubbery or elastomeric properties). Other elastomers that may be used include natural and synthetic rubbers. The synthetic rubbers typically derive from the polymerization of conjugated diene monomers, the copolymerization of conjugated diene monomers with other monomers such as vinyl-substituted aromatic monomers, or the copolymerization of ethylene with one or more α-olefins and optionally one or more diene monomers.

Exemplary synthetic rubbers, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures. Natural rubber is synthesized by and obtained from plant life. For example, natural rubber can be obtained from Hevea rubber trees, guayule shrub, gopher plant, mariola, rabbitbrush, milkweeds, goldenrods, pale Indian plantain, rubber vine, Russian dandelions, mountain mint, American germander, and tall bellflower.

Generally, the rubber compositions of this invention include from about 30 to about 65, in other embodiments from about 35 to about 60, and in other embodiments from about 40 to about 55 weight percent rubber (i.e. the rubber component), based on the total weight of the tire component, of rubber.

In one or more embodiments, the rubber component of the rubber compositions of this invention include from about 1 to about 100 wt %, in other embodiments from about 10 to about 90 wt %, and in other embodiments from about 20 to about 80 wt % of the branched polymers produced by the techniques of this invention.

As indicated above, the rubber compositions may include fillers such as inorganic and organic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). Carbon blacks and silicas are the most common fillers used in manufacturing tires. In certain embodiments, a mixture of different fillers may be advantageously employed.

The amount of total filler employed in the rubber compositions can be up to about 150 parts by weight per 100 parts by weight of rubber (phr), with about 5 to about 125 phr, or about 30 to about 110 phr, being typical. In certain embodiments the total filler content is greater than about 100 phr. In other embodiments, the total filler content is from about 50 to about 100 phr, and in in further embodiments from about 55 to about 95 phr.

In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

In one or more embodiments, the amount of carbon black employed in the rubber compositions can be up to about 75 parts by weight per 100 parts by weight of rubber (phr), with about 5 to about 6 parts by weight phr, or about 10 to about 55 parts by weight phr, being used in exemplary embodiments.

In one or more embodiments, silicas may be characterized by their surface areas, which give a measure of their reinforcing character. The Brunauer, Emmet and Teller (“BET”)method (described in J. Am. Chem. Soc., 1939, vol. 60, 2 p. 309-319) is a recognized method for determining the surface area. The BET surface area of silica is generally less than 450 m²/g. Useful ranges of surface area include from about 32 to about 400 m²/g, about 100 to about 250 m²/g, and about 150 to about 220 m²/g. In one or more embodiments, the silica may be characterized by a pH of from about 5 to about 7 or slightly over 7, or in other embodiments from about 5.5 to about 6.8. In certain embodiments, the silica employed in the rubber composition is derived from rice husk ash only, and in other embodiments the rubber compositions do not include silica from non-rice husk ash derived processes.

Some commercially available silicas which may be used include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J.M. Huber Corp. (Edison, N.J.).

In one or more embodiments, the rubber compositions may include from about 1 to about 150, in other embodiments from about 5 to about 140, and in other embodiments from about 10 to about 130 parts by weight silica per 100 parts by weight rubber. In particular embodiments, the present invention includes rubber compositions with high silica loadings, such as loadings greater than 70, in other embodiments greater than 90, and in other embodiments greater than 110 parts by weight silica per 100 parts by weight rubber, with the useful upper end being limited by the high viscosity imparted by silica. When silica is used together with carbon black, the amount of the silica or carbon black can be can be as low as about 1 phr. In one or more embodiments, where carbon black and silica are employed in combination as a filler, the weight ratio or silica to total filler may be from about 5% to about 99% of the total filler, or in other embodiments from about 10% to about 90% of the total filler, or in yet other embodiments from about 50% to about 85% of the total filler.

In one or more embodiments, where silica is employed as a filler (alone or in combination with other fillers), a coupling agent may be added to the rubber compositions during mixing in order to enhance the interaction of silica with the elastomers. Useful coupling agents are disclosed in U.S. Pat. Nos. 3,842,111; 3,873,489; 3,978,103; 3,997,581; 4,002,594; 5,580,919; 5,583,245; 5,663,396; 5,674,932; 5,684,171; 5,684,172; 5,696,197; 6,608,145; 6,667,362; 6,579,949; 6,590,017; 6,525,118; 6,342,552; and 6,683,135; which are incorporated herein by reference.

In one or more embodiments, the amount of coupling agent may be from about 2 to about 30 wt %, in other embodiments from about 4 to about 25 wt %, and in other embodiments from about 6 to about 20 wt % based on the weight of silica within the composition.

In one or more embodiments, where silica is employed as a filler (either alone or in combination with other fillers), a silica dispersing agent, which may include silica shielding agents, may be included in the rubber formulations. The use of one or more silica dispersing agents has been found to be particularly useful in practicing the present invention in view of the multifunctional polymers and/or high silica loadings. In one or more embodiments, useful silica dispersing agents include alkyl alkoxysilanes, fatty acid esters of hydrogenated or non-hydrogenated C₅ or C₆ sugars, polyoxyethylene derivatives of fatty acid esters of hydrogenated or non-hydrogenated C₅ or C₆ sugars, and esters of polyols, including glycols and polyhydroxy compounds, and mixtures thereof. In particular embodiments, the silica dispersing agent is glycol monostearate. Useful silane dispersing agents are disclosed in U.S. Pat. Nos. 6,608,145, 7,799,870, 7,897,661, 8,962,746, 9,758,639, 9,951,208, and U.S. Publication Nos. 2004/0152811, and 2005/0070672, which are incorporated herein by reference.

In other embodiments, useful silica dispersing agents include metal glycerolates such as zinc glycerolate, calcium glycerolate, and magnesium glycerolate. These compounds are described in greater detail in U.S. Pat. Nos. 10,087,306 and 11,220,595, and U.S. Publication No. 2021/0388188, which are incorporated herein by reference.

In one or more embodiments, the rubber compositions of the invention may include from about 0.1 to about 30 wt %, in other embodiments from about 1.0 to about 25 wt %, in other embodiments from about 3.0 to about 20 wt %, and in other embodiments from about 4.0 to about 10 wt % silica dispersing agent based on the weight of the silica within the composition. In one or more embodiments, the rubber compositions include greater than 3 wt %, in other embodiments greater than 5 wt %, and in other embodiments greater than 7 wt % dispersing agent based upon the weight of the silica. In these or other embodiments, the rubber compositions may include greater than 3 parts by weight, in other embodiments greater than 4 parts by weight, in other embodiments greater than 5 parts by weight, and in other embodiments greater than 6 parts by weight silica dispersing agent per 100 parts by weight rubber.

A multitude of rubber curing agents (also called vulcanizing agents) may be employed, including sulfur or peroxide-based curing systems. Curing agents are described in Kirk-Othmer, Encyclopedia of Chemical Technology, Vol. 20, pgs. 365-468, (3^{rd} Ed. 1982), particularly Vulcanization Agents and Auxiliary Materials, pgs. 390-402, and A. Y. Coran, Vulcanization, Encyclopedia of Polymer Science and Engineering, (2^{nd} Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants. In particular embodiments, the oils that are employed include those conventionally used as extender oils, which are described above. Generally, the rubber compositions of this invention can include from about 1 to about 70 parts by weight, or in other embodiments from about 5 to about 50 parts weight total oil per 100 parts by weight rubber.

All ingredients of the rubber compositions can be mixed with standard mixing equipment such as, but not limited to, Banbury mixers, Brabender mixers, intermesh mixers including tandem intermesh mixers, extruders, kneaders, and two-roll mills. In one or more embodiments, the ingredients are mixed in two or more stages. In the first stage (often referred to as the masterbatch mixing stage), a so-called masterbatch, which typically includes the rubber component and filler, is prepared. To prevent premature vulcanization (also known as scorch), the masterbatch may exclude vulcanizing agents. The masterbatch may be mixed at a starting temperature of from about 25° C. to about 125° C. with a discharge temperature of about 135° C. to about 180° C. Once the masterbatch is prepared, the vulcanizing agents may be introduced and mixed into the masterbatch in a final mixing stage, which is typically conducted at relatively low temperatures so as to reduce the chances of premature vulcanization. Optionally, additional mixing stages, sometimes called remills, can be employed between the masterbatch mixing stage and the final mixing stage. One or more remill stages are often employed where the rubber composition includes silica as the filler. Various ingredients including the polymers of this invention can be added during these remills.

The mixing procedures and conditions particularly applicable to silica-filled tire formulations are described in U.S. Pat. Nos. 5,227,425; 5,719,207; and 5,717,022, as well as European Patent No. 890,606, all of which are incorporated herein by reference. In one embodiment, the initial masterbatch is prepared by including the polymer and silica in the substantial absence of coupling agents and shielding agents.

The rubber compositions prepared from the polymers of this invention are particularly useful for forming tire components such as treads, subtreads, sidewalls, body ply skims, bead filler, and the like. In one or more embodiments, these tread or sidewall formulations may include from about 10% to about 100% by weight, in other embodiments from about 35% to about 90% by weight, and in other embodiments from about 50% to about 80% by weight of the polymer of this invention based on the total weight of the rubber within the formulation.

Where the rubber compositions are employed in the manufacture of tires, these compositions can be processed into tire components according to ordinary tire manufacturing techniques including standard rubber shaping, molding and curing techniques. Typically, vulcanization is effected by heating the vulcanizable composition in a mold; e.g., it may be heated to about 140° C. to about 180° C. Cured or crosslinked rubber compositions may be referred to as vulcanizates, which generally contain three-dimensional polymeric networks that are thermoset. The other ingredients, such as fillers and processing aids, may be evenly dispersed throughout the crosslinked network. Pneumatic tires can be made as discussed in U.S. Pat. Nos. 5,866,171; 5,876,527; 5,931,211; and 5,971,046, which are incorporated herein by reference.

### EXAMPLES

In order to demonstrate the practice of the present invention, the following examples have been prepared and tested. The examples should not, however, be viewed as limiting the scope of the invention. The claims will serve to define the invention.

### Polymer Samples 1-4

### Sample 1: Synthesis of Unfunctional Branched SBR

A nitrogen purged jacketed steel reactor was charged with 2.76 lbs of anhydrous hexanes, 2.33 mL of 1,3-diisopropenylbenzene (5.85 M, 1 eq. vs Li), 2.64 mL 2,2-bis(2′-tetrahydrofuryl)propane (Modifier) (1.6 M in hexane, 0.31 eq. vs Li), and 9.72 mL Sec-BuLi (1.4 M in cyclohexane, 2.00 mmol per hundred gram monomer). The reaction mixture was stirred under inert atmosphere at 80° F. for 30 minutes. The reactor was charged with a mixture of 0.47 lbs of 32.2 weight % styrene in hexane, and 6.55 lbs of 20.6 weight % butadiene in hexane that was previously mixed in a charging can. Immediately, 2.12 mL of potassium tert-amylate (KTA) (0.9 M in cyclohexane, 0.14 eq. Vs Li) was added to the reactor and the jacket temperature was set to 140° F. The solution temperature and reactor pressure were monitored via sensors located inside the vessel. The batch temperature peaked at 181° F. after 15 minutes. After an additional 40 minutes, the polymerization was quenched by dropping the polymer cement into a bucket containing about 8 L isopropyl alcohol (IPA) and 15 g of 2,6-di-tert-butyl-4-methylphenol. The polymers were coagulated, drum dried, and analyzed, and the results of the analysis are reported in Table I.

### Sample 2: Synthesis of Unfunctional Branched SBR

A batch of SBR cement was prepared as described in Sample 1, except that following charging, immediately, 3.18 mL of potassium tert-amylate (KTA) (0.9 M in cyclohexane, 0.21 eq. Vs Li) was added to the reactor. The batch temperature peaked at 181° F. after 13 minutes. After an additional 40 minutes, the polymerization was quenched by dropping the polymer cement into a bucket containing about 8 L isopropyl alcohol (IPA) and 15 g of 2,6-di-tert-butyl-4-methylphenol. The polymers were coagulated, drum dried, and analyzed, and the results of the analysis are reported in Table I.

### Sample 3: Synthesis of Unfunctional Branched SBR

A batch of SBR cement was prepared as described in Sample 1, except that following charging, immediately, 4.23 mL of potassium tert-amylate (KTA) (0.9 M in cyclohexane, 0.28 eq. Vs Li) was added to the reactor. The batch temperature peaked at 182° F. after 14 minutes. After an additional 40 minutes, the polymerization was quenched by dropping the polymer cement into a bucket containing about 8 L isopropyl alcohol (IPA) and 15 g of 2,6-di-tert-butyl-4-methylphenol. The polymers were coagulated, drum dried, and analyzed, and the results of the analysis are reported in Table I.

### Sample 4: Synthesis of Unfunctional Branched SBR

A batch of SBR cement was prepared as described in Sample 1, except that following charging, immediately, 5.29 mL of potassium tert-amylate (KTA) (0.9 M in cyclohexane, 0.35 eq. Vs Li) was added to the reactor. The batch temperature peaked at 176° F. after 13 minutes. After an additional 40 minutes, the polymerization was quenched by dropping the polymer cement into a bucket containing about 8 L isopropyl alcohol (IPA) and 15 g of 2,6-di-tert-butyl-4-methylphenol. The polymers were coagulated, drum dried, and analyzed, and the results of the analysis are reported in Table I.

TABLE I

| | | | | |
|---|---|---|---|---|
| Samples | 1 | 2 | 3 | 4 |

Aging Conditions

| | | | | |
|---|---|---|---|---|
| KTA Loading | 0.14 | 0.21 | 0.28 | 0.35 |

Base Peak

| | | | | |
|---|---|---|---|---|
| Mn (kg/mol) | 135 | 152 | 147 | 154 |
| Mw (kg/mol) | 166 | 170 | 169 | 168 |
| Mp (kg/mol) | 169 | 178 | 178 | 171 |
| Mw/Mn | 1.233 | 1.122 | 1.144 | 1.086 |

Coupled peak

| | | | | |
|---|---|---|---|---|
| Mn (kg/mol) | 479 | 465 | 536 | 580 |
| Mw (kg/mol) | 653 | 581 | 776 | 946 |
| Mp (kg/mol) | 343 | 348 | 328 | 330 |
| Mw/Mn | 1.362 | 1.249 | 1.447 | 1.629 |

Total

| | | | | |
|---|---|---|---|---|
| Mn (kg/mol) | 181 | 192 | 202 | 228 |
| Mw (kg/mol) | 340 | 298 | 395 | 509 |
| Mp (kg/mol) | 169 | 178 | 178 | 171 |
| PDI − Mw/Mn | 1.878 | 1.553 | 1.955 | 2.235 |

Other Properties

| | | | | |
|---|---|---|---|---|
| Styrene | 11.4 | 11.2 | 11.4 | 11.8 |
| % 1,2-butadiene | 57.8 | 63.2 | 59 | 57.6 |
| % 1,4-butadiene | 42.2 | 36.8 | 41 | 42.4 |
| Tg (° C.) | −43.8 | −41.2 | −44.4 | −42.9 |
| % coupling | 35.8 | 31 | 37.2 | 43.9 |
| ML(1 + 4) | 25 | 21.3 | 27.2 | 33.9 |
| T₈₀ | 2.5 | 2.1 | 5.3 | 12.1 |

Samples 1-4 were analyzed according to the following. A Tosoh Ecosec HLC-8320 GPC system and Tosoh TSKgel GMHxl-BS columns with THE as a solvent were used to determine the number average (Mn) and weight average (Mw) molecular weights. The system was calibrated using polystyrene (PS) standards and referenced to PS. The styrene and vinyl content of the polymer was determined by 400 MHz NMR using CDCl₃ as the solvent. The Mooney viscosities (ML₁₊₄) were determined at 100° C. by using a Monsanto Mooney viscometer with a large rotor, a one-minute warm-up time, and a four-minute running time. NMR was used to determine bound styrene, mole percent vinyl, and weight percent ethylene oxide.

### Samples 5-11

### Sample 5: Synthesis of N,N-bis(trimethylsilyl)aminopropylmethyldimethoxysilane Functionalized Branched SBR

A nitrogen purged jacketed steel reactor was charged with 2.76 lbs of anhydrous hexanes, 2.33 mL of diisopropenylbenzene (5.85 M, 1 eq. vs Li), 2.64 mL 2,2-bis(2′-tetrahydrofuryl)propane (1.6 M in hexanes, 0.31 eq. vs Li), and 9.72 mL Sec-BuLi (1.4 M in cyclohexane, 2.00 mmol per hundred gram monomer). The reaction mixture was stirred under inert atmosphere at 27° C. for 30 minutes. The reactor was charged with a mixture of 0.47 lbs of 32.2 weight % styrene in hexanes, and 6.55 lbs of 20.6 weight % butadiene in hexanes. Immediately, 4.23 mL of potassium tert-amylate (KTA) (0.9 M in cyclohexane, 0.28 eq. Vs Li) was added to the reactor and the jacket temperature was set to 60° C. The batch temperature peaked at 78° C. after 16 minutes. After an additional 40 minutes, N,N-bis(trimethylsilyl)aminopropylmethyldimethoxysilane (2.8 M, 1 eq. Vs Li) was added as the functionalizing agent and the reaction was allowed to progress for an additional hour. The polymerization was quenched by dropping the polymer cement into a bucket containing about 8 L isopropyl alcohol and 15 g of 2,6-di-tert-butyl-4-methylphenol. The obtained polymer was analyzed and the results of these testing methods are reported in Table II.

### Sample 6: Synthesis of N,N-bis(trimethylsilyl)aminopropylmethyldimethoxysilane Functionalized Higher Molecular Weight Branched SBR

A nitrogen purged jacketed steel reactor was charged with 2.63 lbs of anhydrous hexanes, 1.66 mL of diisopropenylbenzene (5.85 M, 1 eq. vs Li), 1.88 mL 2,2-bis(2′-tetrahydrofuryl)propane (1.6 M in hexanes, 0.31 eq. vs Li), and 6.94 mL Sec-BuLi (1.4 M in cyclohexane, 1.43 mmol per hundred gram monomer). The reaction mixture was stirred under inert atmosphere at 27° C. for 30 minutes. The reactor was charged with a mixture of 0.47 lbs of 32.2 weight % styrene in hexanes, and 6.55 lbs of 20.6 weight % butadiene in hexanes. Immediately, 4.23 mL of potassium tert-amylate (KTA) (0.9 M in cyclohexane, 0.28 eq. Vs Li) was added to the reactor and the jacket temperature was set to 60° C. The batch temperature peaked at 81° C. after 13 minutes. After an additional 40 minutes, N,N-bis(trimethylsilyl)aminopropylmethyldimethoxysilane (2.8 M, 1 eq. Vs Li) was added as the functionalizing agent and the reaction was allowed to progress for an additional hour. The polymerization was quenched by dropping the polymer cement into a bucket containing about 8 L isopropyl alcohol and 15 g of 2,6-di-tert-butyl-4-methylphenol. The obtained polymer was analyzed and the results of these testing methods are reported in Table II.

Sample 7: Synthesis 3-(1,3-dimethylbutylidene)aminopropyldiethoxysilane Functionalized Branched Polymer

A nitrogen purged jacketed steel reactor was charged with 2.63 lbs of anhydrous hexanes, 2.33 mL of diisopropenylbenzene (5.85 M, 1 eq. vs Li), 2.64 mL 2,2-bis(2′-tetrahydrofuryl)propane (1.6 M in hexanes, 0.31 eq. vs Li), and 9.72 mL Sec-BuLi (1.4 M in cyclohexane, 2.00 mmol per hundred gram monomer). The reaction mixture was stirred under inert atmosphere at 27° C. for 30 minutes. The reactor was charged with a mixture of 0.47 lbs of 32.2 weight % styrene in hexanes, and 6.68 lbs of 20.2 weight % butadiene in hexanes. Immediately, 4.23 mL of potassium tert-amylate (KTA) (0.9 M in cyclohexane, 0.28 eq. Vs Li) was added to the reactor and the jacket temperature was set to 60° C. The batch temperature peaked at 77° C. after 17 minutes. After an additional 40 minutes, 3-(1,3-dimethylbutylidene)aminopropyldiethoxysilane functionalized (2.8 M, 1 eq. Vs Li) was added as the functionalizing agent and the reaction was allowed to progress for an additional hour. The polymerization was quenched by dropping the polymer cement into a bucket containing about 8 L isopropyl alcohol and 15 g of 2,6-di-tert-butyl-4-methylphenol. The obtained polymer was analyzed and the results of these testing methods are reported in Table II.

### Sample 8: Synthesis of Hexamethylcyclotrisiloxane Functionalized Branched Polymer

A nitrogen purged jacketed steel reactor was charged with 2.79 lbs of anhydrous hexanes, 2.33 mL of diisopropenylbenzene (5.85 M, 1 eq. vs Li), 2.64 mL 2,2-bis(2′-tetrahydrofuryl)propane (1.6 M in hexanes, 0.31 eq. vs Li), and 9.72 mL Sec-BuLi (1.4 M in cyclohexane, 2.00 mmol per hundred gram monomer). The reaction mixture was stirred under inert atmosphere at 27° C. for 30 minutes. The reactor was charged with a mixture of 0.47 lbs of 32.2 weight % styrene in hexanes, and 6.52 lbs of 20.7 weight % butadiene in hexanes. Immediately, 4.23 mL of potassium tert-amylate (KTA) (0.9 M in cyclohexane, 0.28 eq. Vs Li) was added to the reactor and the jacket temperature was set to 60° C. The batch temperature peaked at 73° C. after 17 minutes. After an additional 40 minutes, hexamethylcyclotrisiloxane (1.0 M, 1 eq. Vs Li) was added as the functionalizing agent and the reaction was allowed to progress for an additional 30 minutes. It should be noted that upon addition of hexamethylcyclotrisiloxane, the polymer cement in the reactor turned into gel. The functionalization reaction was quenched by charging 10 mL of IPA into the reactor and then the polymer cement was dropped into a bucket containing about 8 L isopropyl alcohol and 15 g of 2,6-di-tert-butyl-4-methylphenol. The obtained polymer was analyzed and the results of these testing methods are reported in Table II.

### Sample 9: Synthesis of Polydimethylsiloxane Functionalized Branched Polymer

A nitrogen purged jacketed steel reactor was charged with 2.92 lbs of anhydrous hexanes, 2.33 mL of diisopropenylbenzene (5.85 M, 1 eq. vs Li), 2.64 mL 2,2-bis(2′-tetrahydrofuryl)propane (1.6 M in hexanes, 0.31 eq. vs Li), and 9.72 mL Sec-BuLi (1.4 M in cyclohexane, 2.00 mmol per hundred gram monomer). The reaction mixture was stirred under inert atmosphere at 27° C. for 30 minutes. The reactor was charged with a mixture of 0.47 lbs of 32.2 weight % styrene in hexanes, and 6.40 lbs of 21.1 weight % butadiene in hexanes. Immediately, 4.23 mL of potassium tert-amylate (KTA) (0.9 M in cyclohexane, 0.28 eq. Vs Li) was added to the reactor and the jacket temperature was set to 60° C. The batch temperature peaked at 75° C. after 16 minutes. After an additional 40 minutes, polydimethylsiloxane (1.19 M, 1 eq. Vs Li) was added as the functionalizing agent and the reaction was allowed to progress for an additional 30 minutes. It should be noted that upon addition of polydimethylsiloxane, the polymer cement in the reactor turned into gel. The functionalization reaction was quenched by charging 10 mL of IPA into the reactor and then the polymer cement was dropped into a bucket containing about 8 L isopropyl alcohol and 15 g of 2,6-di-tert-butyl-4-methylphenol. The polymer was coagulated, and drum dried. The obtained polymer was analyzed and the results of these testing methods are reported in Table II.

### Sample 10: Synthesis of Functional Linear SBR

A nitrogen purged jacketed steel reactor was charged with 2.95 lbs of anhydrous hexanes, 0.47 lbs of a 32.2 wt % styrene in hexanes, and 6.37 lbs of a 21.2 wt % butadiene in hexanes. The reactor was then charged with n-butyllithium (3.54 mL, 1.6 M in hexane, 0.833 mmol per hundred gram monomer), followed by 2,2-bis(2′-tetrahydrofuryl)propane (1.77 mL, 1.6 M in hexanes, 0.5 eq. vs Li) and the jacket temperature was set to 60° C. The batch temperature peaked at 72° C. after 20 minutes. After an additional 30 minutes, N,N-bis(trimethylsilyl)aminopropylmethyldimethoxysilane (2.8 M, 1 eq. Vs Li) was added as the functionalizing agent and the reaction was allowed to progress for an additional hour. The polymerization was quenched by dropping the polymer cement into a bucket containing about 8 L isopropyl alcohol and 15 g of 2,6-di-tert-butyl-4-methylphenol. The obtained polymer was coagulated, and drum dried. The obtained polymer was analyzed and the results of these testing methods are reported in Table II.

### Sample 11: Synthesis of Functional Linear SBR

A nitrogen purged jacketed steel reactor was charged with 5.22 lbs of anhydrous hexanes, 0.31 lbs of a 32.2 wt % styrene in hexanes, and 4.25 lbs of a 21.2 wt % butadiene in hexanes. The reactor was then charged with n-butyllithium (0.72 mL, 2.5 M in hexane, 0.398 mmol per hundred gram monomer), followed by 2,2-bis(2′-tetrahydrofuryl)propane (1.02 mL, 1.6 M in hexanes, 0.9 eq. vs Li) and the jacket temperature was set to 60° C. The batch temperature peaked at 63° C. after 28 minutes. After an additional 90 minutes, N,N-bis(trimethylsilyl)aminopropylmethyldimethoxysilane (2.8 M, 1 eq. Vs Li) was added as the functionalizing agent and the reaction was allowed to progress for an additional hour. The polymerization was quenched by dropping the polymer cement into a bucket containing about 8 L isopropyl alcohol and 15 g of 2,6-di-tert-butyl-4-methylphenol. The obtained polymer was coagulated, and drum dried. The obtained polymer was analyzed and the results of these testing methods are reported in Table II.

TABLE II

| Samples | 5 | 6 | 7 | 8 | 9 | 10 | 11 |
|---|---|---|---|---|---|---|---|
| BuLi (mmphgm) | 2.00 | 1.4 | 2.00 | 2.00 | 2.00 | 0.83 | 0.40 |
| Modifier/BuLi | 0.31 | 0.31 | 0.31 | 0.31 | 0.31 | 0.5 | 0.9 |
| KTA/BuLi | 0.28 | 0.28 | 0.28 | 0.28 | 0.28 | — | — |
| Total Mn (kg/mol) | 216 | 262 | 224 | 254 | 240 | 169 | 446 |
| Total Mp (kg/mol) | 163 | 158 | 168 | 184 | 216 | 157 | 411 |
| Total Mw (kg/mol) | 433 | 1028 | 1054 | 400 | 700 | 171 | 474 |
| Styrene | 12.1 | 14.8 | 12.5 | 11.4 | 14.1 | 11.5 | 11.4 |
| % 1,2-butadiene | 59.3 | 54.7 | 57.7 | 58.1 | 61.5 | 50.9 | 55.7 |
| % 1,4 butadiene | 40.7 | 45.3 | 42.3 | 41.9 | 38.5 | 49.1 | 44.3 |
| Tg (° C.) | −43.5 | −45.6 | −42.7 | −43.1 | −38.7 | −48.7 | −42.9 |
| ML(1 + 4) | 33 | 64 | 32.7 | 49.8 | 180.5 | 6.6 | 87.8 |
| T₈₀ | 4.9 | 30.7 | 6.5 | 4.49 | 118 | 0.9 | 1.5 |
| TN (ppm) | 229.5 | 92.5 | 142.9 | — | — | 132.8 | 62.1 |
| Functionality/Chain | 3.5 | 1.5 | N.D. | N.D. | N.D. | 0.9 | 0.7 |
| Gel content (%) | 1.6 | 0.1 | 58.3 | 1.6 | 19.4 | 0.4 | 0.1 |

*Due to the very high gel content in Example 7, the functionality/chain was not determined due to potential inaccuracy in the concentration of functionality.
*Functionality/chain for Example 8 and 9 was not determined due to the lack of method available to determine the concentration of functionality

Samples 5-11 were analyzed according to the following. GPC-MALS data was collected with a Tosoh EcoSEC GPC system and a Wyatt DAWN-Heleos II MALS detector with each sample being dissolved in THF at approximately 1 mg/mL. The samples were eluted through 2 Tosoh TSKgel GMHxl-BS columns at 1 mL/min with a column oven temperature of 40° C. Absolute molecular weight values were calculated using Wyatt OMNISEC software and a dn/dc value of 0.155 ml/g. The styrene and vinyl content of the polymer was determined by 400 MHz 1H NMR using CDCl₃ as the solvent. The Mooney viscosities (ML₁₊₄) of the polymer samples were determined at 100° C. by using a Monsanto Mooney viscometer with a large rotor, a one-minute warm-up time, and a four-minute running time. Total nitrogen (TN) analysis was performed on (3×) coagulated samples using a Mitsubishi Chemical Analytech NSX-2100 Element Analyzer System.

### Samples 12-16

### Synthesis and Stabilization of a Multifunctional Branched Polymer

A nitrogen-purged, jacketed stainless-steel reactor was charged with 2.89 lbs of anhydrous hexanes, 2.33 mL of diisopropenylbenzene (5.85 M, 1 equiv. vs Li), 2.64 mL 2,2-bis(2′-tetrahydrofuryl)propane (1.6 M in hexane, 0.31 eq vs Li), and 9.72 mL sec-BuLi (1.4 M in cyclohexane, 2.00 mmol per hundred gram monomer). The reaction mixture was stirred under inert atmosphere at 27° C. for 30 min. 0.47 lbs of 32.2 weight % styrene in hexane, and 6.43 lbs of 21.0 weight % butadiene in hexanes were mixed together in a charging can and then charged into the reactor followed by the immediate addition of 4.23 mL of potassium tert-amylate (KTA) (0.9 M in cyclohexane, 0.28 eq vs Li). The jacket temperature was set to 60° C., and the solution temperature and reactor pressure were monitored via sensors located inside the vessel. The batch temperature peaked at 86° C. after 16 minutes. After an additional 40 minutes, 4.13 mL of 3-(1,3-dimethylbutylidene)aminopropyldiethoxysilane (3.1 M, 1 eq vs Li) was added as the functionalizing agent and the reaction was continued for another 60 min. Samples of the product cement were then collected through a needle into dried, purged, sealed 800 mL bottles. The properties of a drum dried sample of the polymer before stabilization were as follows: Tg=−43° C., Mn=217 kg/mol, Mw=334 kg/mol, Mp=287 kg/mol, Mw/Mn=1.54, and percent coupling 77%.

The SBR polymer cement prepared above introduced to the bottles was quenched by adding 3 mL IPA/BHT solution to each bottle. Then, to each of 2 bottles containing approximately 400 g of cement was added stabilizer solutions as shown in Table III. The stabilizers employed were triethoxyoctylsilane, 3.18 M (neat)(OTES), ethyl hexanoic acid, 6.26 M (neat)(EHA), triphenylsilanol, 0.2 M in 20% ethanol in cyclohexane (TPS), and diphenylsilanediol, 0.1 M in 20% ethanol in cyclohexane (DPSDO).

The bottles were agitated in a 50° C. water bath for 30 minutes. The cement from the bottle pairs was then steam desolventized using a mini-steam desolventizer. To the water was added 15 g of polycoat (for Sample 1; the same water was used for subsequent samples and 8 g of polycoat was added each time) and the water was heated to above 80° C. using steam. With the agitator speed set as high as possible without causing splashing, the cement was poured from the bottles into the desolventizer in a slow, controlled manner resulting in crumbed material. The devolatilized polymer was collected and dried in an oven at 70° C. for 12 hours. A portion of the material was then oven-aged at 100° C. for 48 hours. The unaged polymer properties were analyzed by GPC, NMR and DSC, and both unaged and aged samples were analyzed and their Mooney viscosities and T₈₀ values were measured. The results are reported in Table III.

TABLE III

| Samples | 12 | 13 | 14 | 15 | 16 |
|---|---|---|---|---|---|
| Stabilizer | None | OTES/EHA | TPS | TPS | TPS/DPSDO |
| Equivalents of | — | 6.7/2.6 | 1 | 4 | 1/1 |
| stabilizer | | | | | |
| (vs. Li) | | | | | |
| Total mass of | 812.7 | 815.8 | 820.1 | 825.5 | 831.8 |
| cement (g) | | | | | |
| Volume of | — | 5.16/1.02 | 12.30 | 49.53 | 12.48/24.95 |
| stabilizer | | | | | |
| added (mL) | | | | | |

Unaged Data

| | | | | | |
|---|---|---|---|---|---|
| Gel Content | 48% | 60% | 23% | 1% | 14% |
| MS₍₁₊₄₎ | 83.85 | 70.66 | 57.74 | 25.93 | 46.51 |
| T₈₀ (s) | >900 | >900 | 167.74 | 26.14 | 89.96 |

Aged Data

| | | | | | |
|---|---|---|---|---|---|
| Gel Content | 95% | 83% | 75% | 53% | 68% |
| MS_{(1 + 4)} | n.d* | 88.89 | 72.12 | 54.13 | 71.32 |
| T₈₀ (s) | n.d* | >900 | 495.04 | 69.74 | 572.32 |

*Values could not be determined due to extreme degradation of the sample

Various modifications and alterations that do not depart from the scope and spirit of this invention will become apparent to those skilled in the art. This invention is not to be duly limited to the illustrative embodiments set forth herein.

1. A method for preparing a branched polymer, the method comprising:
(i) preparing a multi-site initiator by reacting polyalkenyl compound with an alkyl lithium compound;
(ii) introducing the multi-site initiator, monomer, and a potassium alkoxide to form a polymerization mixture, where the polymerization mixture includes a molar ratio of potassium to lithium of greater than 0.150:1; and
(iii) allowing the monomer to polymerize and form a branched polymer.

2. The method of claim 1, where the polyalkenyl compound is diisopropenyl benzene, and the alkyl lithium is sec-butyl lithium.

3. (canceled)

4. The method of claim 1, where the step of preparing a multi-site initiator includes aging the initiator at a temperature of from about 25 to about 100° C. for greater than 1 minute in the presence of a Lewis base.

5. (canceled)

6. (canceled)

7. (canceled)

8. (canceled)

9. (canceled)

10. The method of claim 1, where introducing the multi-site initiator, monomer and potassium alkoxide takes place with a solvent in which at least one of the multi-site initiator, monomer and potassium alkoxide are soluble to thereby form a polymerization mixture.

11. The method of claim 1, where allowing the monomer to polymerize forms a branched polymer with a plurality of reactive chain ends, and further comprising the step of reacting the branched polymer with a plurality of reactive chain ends with a functionalizing agent to thereby form a branched functionalized polymer.

12. (canceled)

13. (canceled)

14. The method of claim 11, where the functionalizing agent is defined by either the formula 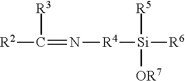
where R², R³, and R⁷ are monovalent organic groups, R⁴ is a divalent organic group, and where R⁵ and R⁶ are each independently hydrocarbyloxy groups or hydrocarbyl groups, or the formula 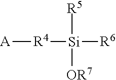
where R⁴ is a divalent organic group, where R⁵ and R⁶ are each independently hydrocarbyloxy groups or hydrocarbyl groups, R⁵ is a monovalent organic group, and A is selected from the group consisting of carboxylic ester, cyclic tertiary amine, non-cyclic tertiary amine, pyridine, silazane, and sulfide groups.

15. (canceled)

16. (canceled)

17. (canceled)

18. (canceled)

19. (canceled)

20. (canceled)

21. (canceled)

22. The method of claim 11, where after the step of reacting the branched polymer with a functionalizing agent to thereby form a branched functionalized polymer, introducing a stabilizing agent to the branched functionalized polymer.

23. The method of claim 22, where the stabilizing agent is an aryl silanol, where the amount of aryl silanol introduced is from about 1 to about 7 moles of aryl silanol per mole of lithium introduced to the polymerization mixture.

24. (canceled)

25. The method of claim 23, where the aryl silanol is selected from the group consisting of triphenylsilanol, diphenylsilanediol, and phenylsilanetriol.

26. The method of claim 11, where after the step of reacting the branched polymer with a functionalizing agent to thereby form a branched functionalized polymer, introducing an aryl silanol and a silane including a hydrolyzable group that forms an acidic species upon hydrolysis to the branched functionalized polymer.

27. (canceled)

28. The method of claim 11, further comprising the step of isolating the branched functionalized polymer from the polymerization mixture.

29. (canceled)

30. The branched polymer of claim 1, where the branched polymer is characterized by a weight average molecular weight of greater than 250 kg/mol, a vinyl content of greater than 10%, a bound styrene of greater than 20%, or some combination thereof.

31. (canceled)

32. (canceled)

33. The branched polymer of claim 29, where the branched polymer is characterized by a T80 (ASTM D1646-19A) of greater than 2 minutes, a Mooney viscosity (ML ₁₊₄ @ 100° C.) of greater than 20, a Tg (ASTM E1356-08) of less than −20° C., or some combination thereof.

34. (canceled)

35. (canceled)

36. (canceled)

37. (canceled)

38. (canceled)

39. (canceled)

40. A vulcanizable composition comprising:
(i) a branched polymer prepared by
(a) providing preparing a multi-site initiator by reacting polyalkenyl compound with an alkyl lithium compound;
(b) introducing the multi-site initiator, monomer, and a potassium alkoxide to form a polymerization mixture, where the polymerization mixture includes a molar ratio of potassium to lithium of greater than 0.150:1; and
(c) allowing the monomer to polymerize and form a branched polymer;
(ii) silica; and
(iii) a curative.

41. The vulcanizable composition of claim 40, further comprising a silica coupling agent, a silica dispersing agent, or some combination thereof.

42. (canceled)

43. (canceled)

44. (canceled)

45. (canceled)

46. (canceled)

47. The vulcanizable composition of claim 41, where the vulcanizable composition includes greater than 70 parts by weight silica per 100 parts by weight rubber, from about 2 to about 30 wt % silica coupling agent based upon the weight of the silica, from about 0.1 to about 30 wt % silica dispersing agent based upon the weight of the silica, or some combination thereof.

48. (canceled)

49. (canceled)

50. The vulcanizable composition of claim 40, where the branched polymer is a functionalized branched polymer formed by reacting the branched polymer with a functionalizing agent.

51. A vulcanizate prepared by vulcanizing the vulcanizable composition of matter of claim 40.

52. (canceled)

53. (canceled)

54. (canceled)

55. (canceled)

56. (canceled)

57. (canceled)

58. (canceled)

59. (canceled)

60. (canceled)

61. (canceled)

62. (canceled)
